(19) United States
(12) Patent Application Publication
(10) Pub. No.: US 2007/0103551 A1
(43) Pub. Date: May 10, 2007

(54) Method and system for measuring video quality

(75) Inventors: Tae-hee Kim, Suwon-si (KR); Dae-sik Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/581,451

(22) Filed: Oct. 17, 2006

(30) Foreign Application Priority Data
Nov. 9, 2005 (KR) 10-2005-0107036

(51) Int. Cl. H04N 17/00

(52) U.S. Cl. 348/180; 348/181

(57) ABSTRACT

A method for measuring video quality includes: receiving subjective video quality measuring data from a plurality of video quality measurers; photographing or capturing a test-target video image and receiving image data; calculating video quality measurement factor values with respect to the received image data, item by item; reflecting the video quality measurement factor values to the subjective video quality measuring data through video quality modeling; mapping results of the reflecting into scores; weighting the video quality measurement factor values according to their correlations with the subjective video quality measuring data; and outputting objective video quality measuring data on a screen. An associated video quality measuring system includes: a subjective video quality measurement input; an objective video quality measuring; a video quality modeling; and a video quality measuring algorithm unit.

### CROSS-REFERENCE TO RELATED APPLICATIONS

This application claims priority from Korean Patent Application No. 10-2005-0107036, filed on Nov. 9, 2005, in the Korean Intellectual Property Office, the disclosure of which is incorporated herein by reference in its entirety.

### BACKGROUND OF THE INVENTION

1. Field of the Invention

Methods and systems consistent with the present invention relate to measuring video quality, and more particularly, to calculating a plurality of objective video quality measuring data based on subjective video quality measuring data obtained by a plurality of video quality measuring groups, mapping the results into scores, applying weights according to correlations, and summing up the weighted scores, thereby obtaining a video quality measurement result.

2. Description of the Related Art

Video experts generally aim to provide video images that can most conspicuously appeal to a viewer. For this, they measure video quality. The video quality in a video system is measured by a skilled video quality measurer. That is, the video quality measurer performs a subjective measurement based on the measurer's evaluation of several measurement items while viewing a test video. The measurer subjectively measures the video quality and writes associated scores on a subjective video quality measuring report. For example, the measurer writes “(1) clarity: 22, (2) contrast ratio of lightness to darkness: 25, (3) brightness: 10, (4) color reproduction: 15, (5) noise: 9, and (6) total score: 81″ on the video quality measuring report.

However, the result obtained by such a subjective video quality measuring method is subject to variation because it is susceptible to the subjectivity of the measurer and various video quality viewing environments that affect the video quality.

Although the subjective video quality measuring method most closely expresses the video quality a human being can feel and has a direct relationship to video quality as sensed by the measurer, it has problems of inaccuracy and time-variance. Also, in the subjective video quality measuring method, since many numbers of groups might have to attend to the video quality measurement of all display systems under development, large amounts of time, effort, and cost are required, which may decelerate the development of the associated display systems.

### SUMMARY OF THE INVENTION

The present invention provides a method and system which obtains a video quality measurement result by calculating a plurality of objective video quality measuring data based on subjective video quality measuring data obtained by a plurality of video quality measuring groups, mapping the calculated values into scores, applying weights according to correlations, and summing up the weighted scores, thereby obtaining a video quality measurement result.

According to an aspect of the present invention, there is provided a method for measuring video quality, comprising receiving subjective video quality measuring data from a plurality of video quality measurers; photographing or capturing a target-test video image and receiving image data; calculating video quality measurement factor values with respect to the received image data, item by item; reflecting the video quality measurement factor values to the subjective video quality measuring data through video quality modeling; mapping results of the reflecting into scores; weighting the video quality measurement factor values according to their correlations with the subjective video quality measuring data; and outputting objective video quality measuring data on a screen.

According to another aspect of the present invention, there is provided a video quality measuring system, comprising a subjective video quality measurement input unit that receives subjective video quality measuring data from a plurality of video quality measurers; an objective video quality measuring unit that receives image data which is obtained by photographing a test target video image, and calculates video quality measurement factor values with respect to the received image data, item by item, the item being the video quality measurement item; a video quality modeling unit that reflects the video quality measurement factor values to the subjective video quality measuring data through video quality modeling and maps the results of the reflecting into scores; and a video quality measuring algorithm unit that weights the video quality measurement factor values according to their correlations with the subjective video quality measuring data and outputs objective video quality measuring data on a screen.

The objective video quality measuring unit comprises a video displayer that outputs video data, which is a target to be measured, on a screen; a photographing device that photographs or captures a video output from the video displayer and inputs it as image data; and a measurement data calculator that calculates numerical data with respect to the photographed or captured image data, item by item, the items being video quality measurement items.

The subjective video quality measuring data includes metrics regarding clarity, contrast ratio of lightness to darkness, brightness, color reproduction, and noise.

The clarity has metrics including Y-Preshoot, Y-Overshoot, Y-Ringing, and modulation transfer function (MTF); the contrast ratio of lightness to darkness has metrics including black and white saturation, gamma curve, contrast ratio, and black level; the brightness has metrics including luminance histogram and luminance; the color reproduction has metrics including color histogram, RGB (red, green, blue) color coordinates, skin color coordinates, white balance, and color saturation; the noise has metrics including quantization noise and C/Y-SN; and the distortion characteristic has metrics including H/V linearity and circle-distortion.

The objective video quality measuring unit has video quality measurement correlations with respect to metrics of the video quality measurement items. Each of the metrics includes its own single measurement value and the result of reflecting the video quality measurement factor values to the subjective video quality measuring data includes a single weight factor for each measurement value. The objective video quality measuring data is obtained by multiplying the metric measurement values by respective weight factors of the metric measurement values and summing up the multiplied values.

The objective video quality measuring data is output as numerical data with respect to each measurement item and also is output as measurement contents for each measurement item.

### BRIEF DESCRIPTION OF THE DRAWINGS

The above and other aspects of the present invention will become more apparent by describing exemplary embodiments of the present invention with reference to the accompanying drawings, in which:

FIG. 1 is a block diagram illustrating a video quality measuring system according to an exemplary embodiment of the present invention;

FIG. 2 is a view schematically illustrating an objective video quality measuring unit of the video quality measuring system of FIG. 1;

FIG. 3 is a flowchart illustrating a method for measuring video quality according to an exemplary embodiment of the present invention;

FIG. 4 is a table illustrating measurement items, maximum number of points, and points in score for an example subjective video quality measurement;

FIG. 5 is a view illustrating a video quality index to measure a test-target video;

FIG. 6 is a view illustrating a video quality index containing video quality measurement items, each having metrics;

FIG. 7 is a table illustrating video quality measurement items, metrics used, and correlation for each item in an example combination of subjective video quality measuring data and video quality measurement factor values;

FIG. 8 is a table illustrating measurement items, maximum number of points, class, points in score, and absolute variation in deciding a video quality measurement result;

FIG. 9A is a table illustrating metrics that include sample equalized maximum point scores;

FIG. 9B is a graph illustrating a relationship between a physical metric and video quality perception with the sample equalized maximum point scores of FIG. 9A; and

FIG. 10 is a view illustrating a result of measuring the video quality.

### DETAILED DESCRIPTION OF EXEMPLARY EMBODIMENTS

The matters defined in the description, such as a detailed construction and elements, are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

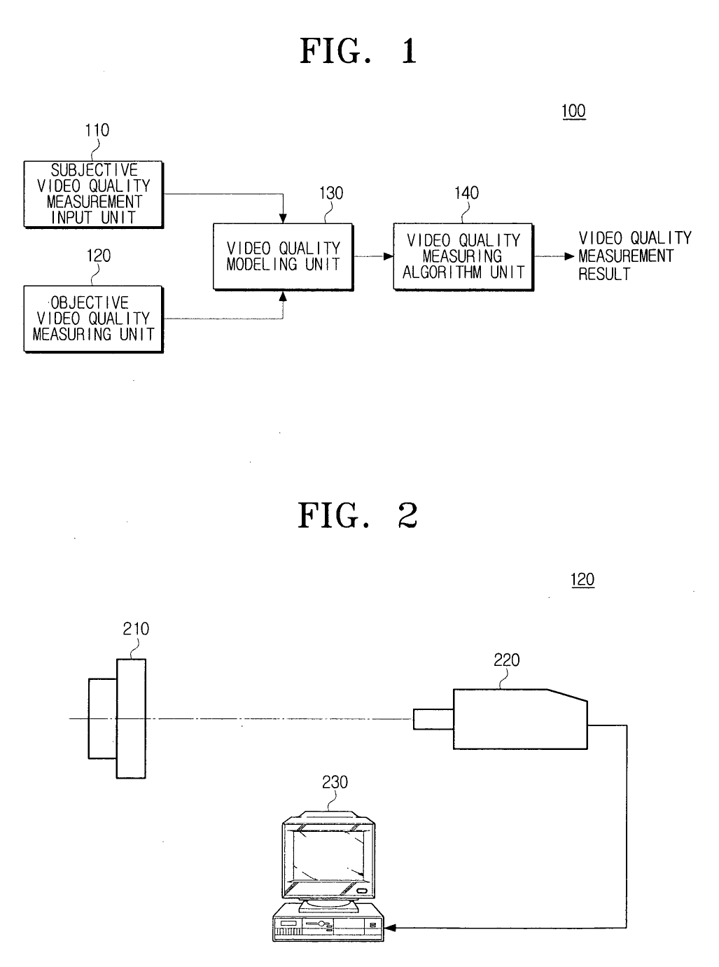

FIG. 1 is a block diagram illustrating a video quality measuring system according to an exemplary embodiment of the present invention.

Referring to FIG. 1, the video quality measuring system 100 comprises a subjective video quality measurement input unit 110, an objective video quality measuring unit 120, a video quality modeling unit 130, and a video quality measuring algorithm unit 140.

The subjective video quality measurement input unit 110 receives subjective video quality measuring data from a plurality of video quality measurers. For example, each video quality measurer inputs his/her measured video quality data through a key input device such as keyboard. Also, the subjective video quality measurement input unit 110 provides the plurality of video quality measurers with an input display regarding measurement items, and receives subjective video quality measuring data from the video quality measurers, item by item, through the input display.

The objective video quality measuring unit 120 photographs a video output from a video displayer and receives image data, and calculates video quality measurement factor values with respect to the input image data, item by item.

The video quality modeling unit 130 reflects the video quality measurement factor values calculated by the objective video quality measuring unit 120 to the subjective video quality measuring data through video quality modeling, and maps the results of the reflection into scores. At this time, the video quality modeling is to make the objective video quality measurement factor values approximate the subjective video quality measuring data such that they have a similar score difference.

The video quality measuring algorithm unit 140 calculates the objective video quality measuring data by weighting the video quality measurement factor values and the subjective video quality measuring data according to their correlations, and outputs the objective video quality measuring data. The objective video quality measuring data output from the video quality measuring algorithm unit 140 is numerical data about each measurement item, and indicates measurement contents for the items.

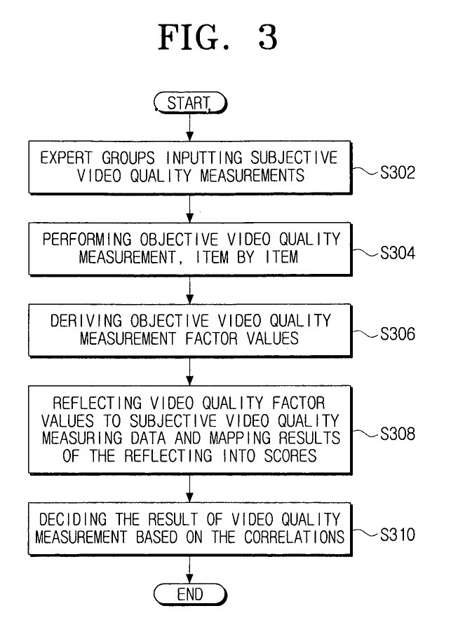

FIG. 2 is a view showing the structure of the objective video quality measuring unit 120 of the video quality measuring system 100.

As shown in FIG. 2, the objective video quality measuring unit 120 comprises a video displayer 210, a photographing device 220, and a measurement data calculator 230.

The video displayer 210 displays test-target video data to measure on a screen.

The photographing device 220 photographs or captures video displayed on the video displayer 210 and outputs it as image data.

The measurement data calculator 230 calculates numerical data with respect to the photographed or captured image data, item by item. For example, the measurement data calculator 230 uses a computer having the capability of analyzing the image data output from the photographing device 220 and calculating numerical data, item by item.

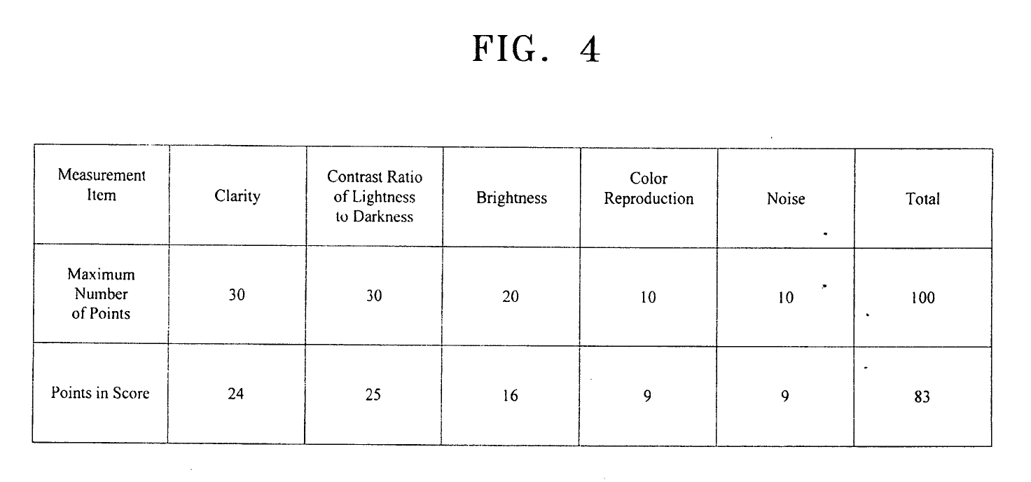

FIG. 3 is a flowchart illustrating a method for measuring video quality according to an exemplary embodiment of the present invention.

The present invention may use an automated objective method for measuring video quality in order to avoid the disadvantages of a subjective video quality measuring method. The automated objective method aims to obtain an objective performance index in order to determine the excellence (or lack thereof) of video quality. Since various video formats may appear in a video stream, a process of obtaining one or more objective video quality measurements has to be automated to promptly analyze different types of video formats. This automation is achieved by the objective video quality measuring unit 120, the video quality modeling unit 130, and the video quality measuring algorithm unit 140.

Also, the objective video quality measurement supposes that the same settings are maintained. Accordingly, it has the same resultant values even if the test is repeated. The video quality measurement provides a viewer with an image that most conspicuously appeals to the viewer's perception. Therefore, a final decision regarding the objective video quality measurement values is based on the degree of correlation between the subjective measurement results and the objective measurement results. A static analysis is used to correlate the subjective measurement results obtained by the subjective video quality measurement input unit 110 with the objective measurement results obtained by the objective video quality measuring unit 120.

First, the subjective video quality measurement input unit 110 receives subjective video quality measurements with respect to a target test video from video image quality measuring expert group(s) at operation S302.

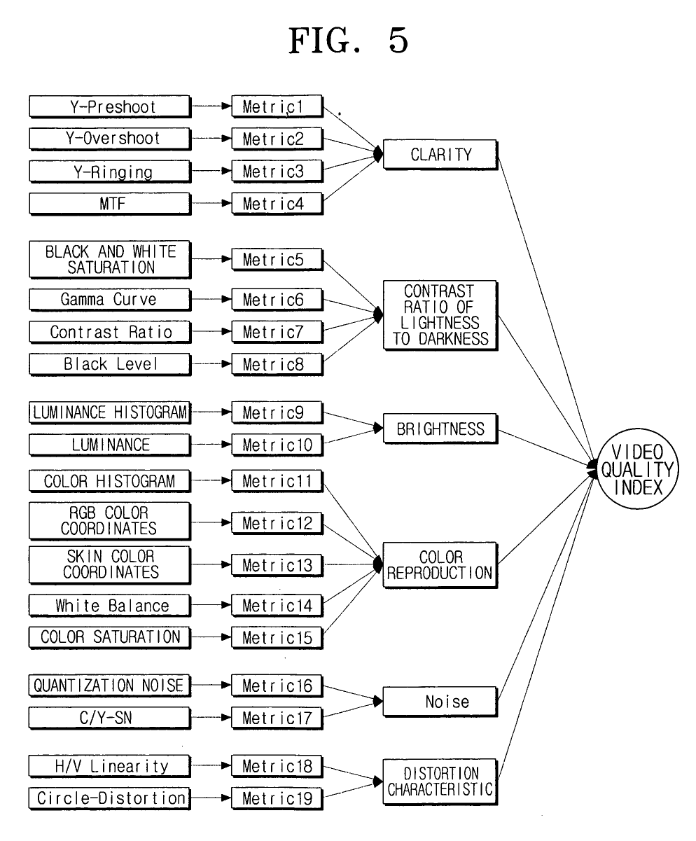

Metrics of the subjective video quality measurement include, for example, clarity, contrast ratio of lightness to darkness, brightness, color reproduction, and noise, as expressed, for example, in FIG. 4.

The subjective video quality measurement input unit 110 receives scores given to the metrics, such as clarity: 24, contrast ratio of lightness to darkness: 25, brightness: 16, color reproduction: 9, and noise: 9.

Next, the video quality measuring system 100 performs objective video quality measurement with respect to the target test video using the objective video quality measuring unit 120, item by item, at operation S304.

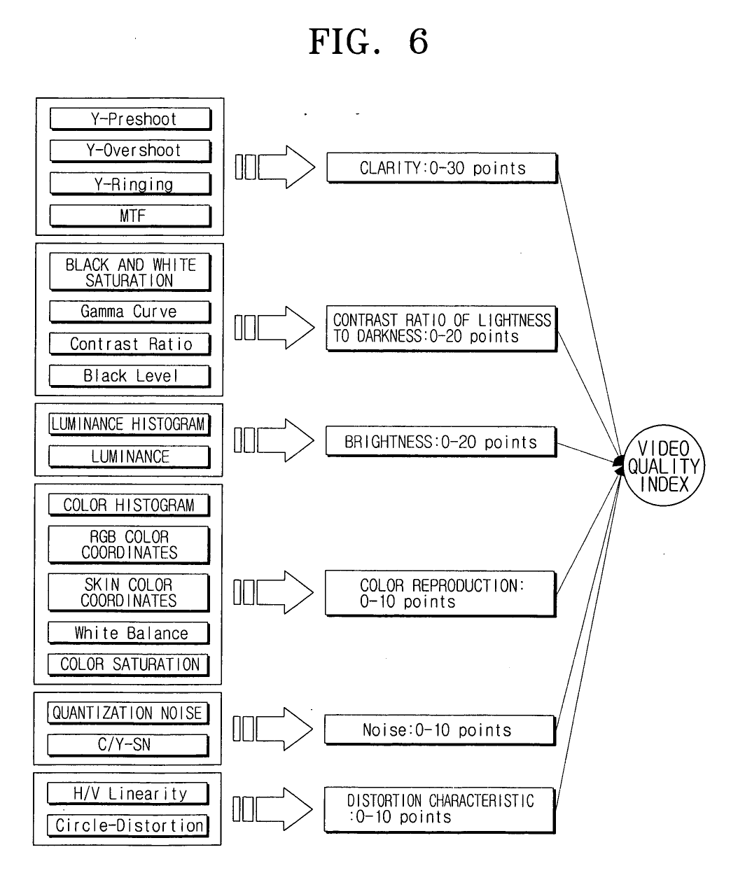

More specifically, the photographing device 220 photographs or captures the video displayed on the video displayer 210 as shown in FIG. 2, and the measurement data calculator 230 measures video quality of the photographed or captured video, item by item, as shown in FIG. 5 and thereby obtains a video quality index expressed by a score.

For example, as shown in FIG. 5, the measurement item “Clarity” has metrics including “Y-Preshoot”, “Y-overshoot”, “Y-Ringing”, “MTF” (modulation transfer function). The item “Contrast Ratio of Lightness to Darkness” has metrics including “Black and White Saturation”, “Gamma Curve”, “Contrast Ratio”, and “Black Level”. The item “Brightness” has metrics including “Luminance Histogram” and “Luminance”. The item “Color Reproduction” has metrics including “Color Histogram”, “RGB Color Coordinates”, “Skin Color Coordinates”, “White Balance”, and “Color Saturation”. Also, the item “Noise” has metrics including “Quantization Noise” and “C/Y-SN”, and the item “Distortion Characteristic” has metrics including “H/V Linearity” and “Circle-Distortion”.

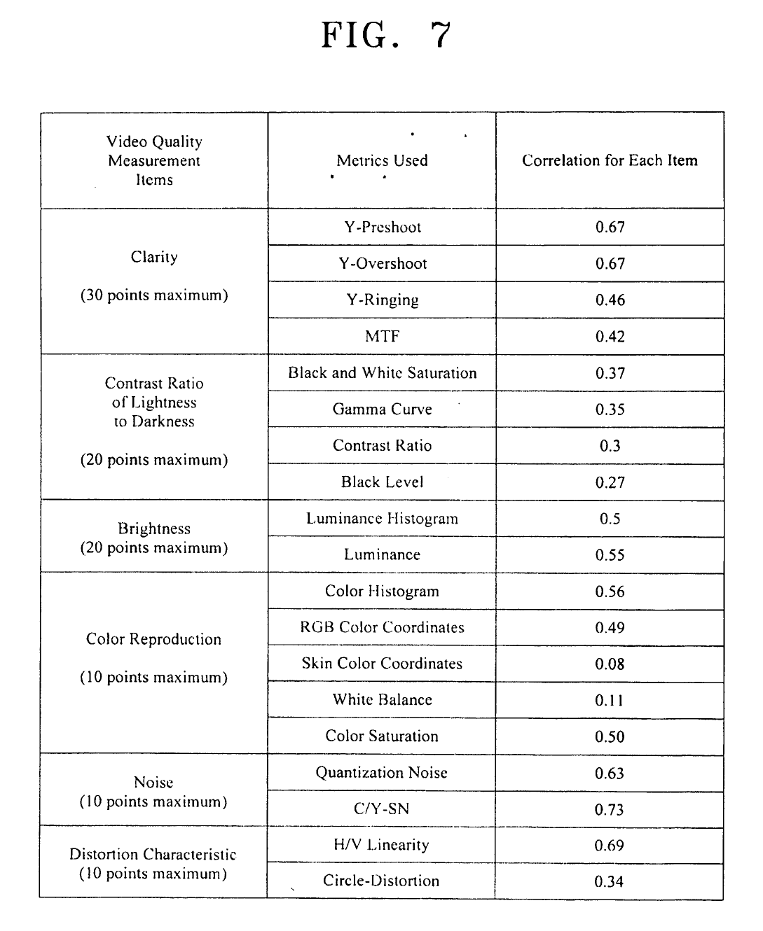

Referring to FIG. 6, the item “Clarity”, including “Y-Preshoot”, “Y-Overshoot”, “Y-Ringing”, and “MTF”, has a video quality index from 0 to 30 points. The item “Contrast Ratio of Lightness to Darkness”, including “Black and White Saturation”, “Gamma Curve”, “Contrast Ratio” and “Black Level”, has a video quality index from 0 to 20 points. The item “Brightness”, including “Luminance Histogram” and “Luminance”, has a video quality index from 0 to 20 points. The item “Color Reproduction”, including “Color Histogram”, “RGB Color Coordinates”, “Skin Color Coordinates”, “White Balance”, and “Color Saturation”, has a video quality index from 0 to 10 points. The item “Noise”, including “Quantization Noise” and “C/Y-SN”, has a video quality index from 0 to 10 points, and the item “Distortion Characteristic”, including “H/V linearity” and “Circle-Distortion”, has a video quality index from 1 to 10 points.

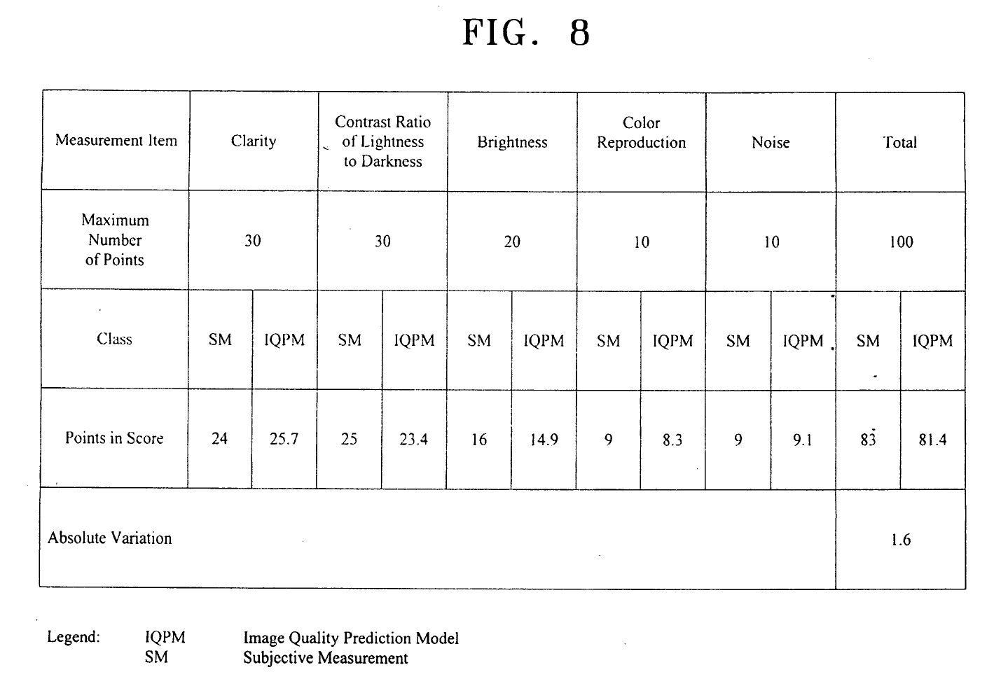

The objective video quality measurement results of selected metrics are combined with correlation results in order to achieve an objective video quality measurement with respect to the target-test video. Accordingly, the video quality modeling unit 130 outputs correlations associated with the respective metrics of the video quality measurement items, as expressed, for example, in FIG. 7.

The objective video quality measuring unit 120 derives objective video quality measurement factor values with respect to the items at operation S306.

More specifically, the objective video quality measuring unit 120 calculates, for example, factor values X1 to X4 regarding the item “Clarity”, calculates factor values X5 to X8 regarding the item “Contrast Ratio of Lightness to Darkness”, calculates factor values X9 and X10 regarding the item “Brightness”, calculates factor values X11 to X15 regarding the item “Color Reproduction”, calculates factor values X16 and X17 regarding the item “Noise”, and calculates factor values X18 and X19 regarding the item “Distortion Characteristic”.

The video quality modeling unit 130 reflects the video quality measurement factor values to the subjective video quality measuring data and maps the results of reflection into scores at operation S308.

Each metric includes its own measurement value and each correlation result includes a weight factor for each measurement value. The scores of the objective video quality measurement are calculated by multiplying metric measurement values by weight factors of the metric measurement values and summing the multiplied values, as expressed, for example, by the following sample equations:
Score=0.75(X1+X2)+0.125(X3+X4) [Equation 1]

Equation 1 calculates a score for the item “Clarity”.

Equation 2 calculates a score for the item “Contrast Ratio of Lightness to Darkness”:
Score=0.625(X5+X6)+0.25(X7+X8) [Equation 2]

Equation 3 calculates a score for the item “Brightness”:
Score=1(X9+X10) [Equation 3]

Equation 4 calculates a score for the item “Color Reproduction”:
Score=0.7(X11+X13+X15)+0.3(X12+X14) [Equation 4]

After the video quality measurement factor values are reflected to the subjective video quality measuring data and mapped into scores as described above, the video quality measuring system 100 finally decides the result of video quality measurement based on the correlations using the video quality measuring algorithm unit 140.

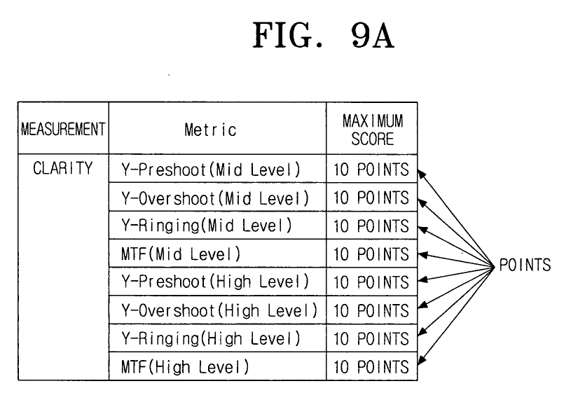

That is, an image quality prediction model (IQPM) value is calculated with respect to the subject video quality measuring data according to correlation, as expressed, for example, in FIG. 8, such that the video quality measurement result is decided.

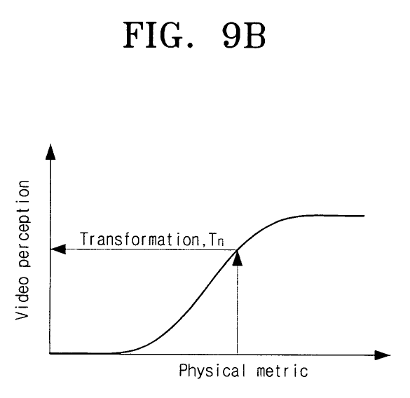

Meanwhile, if the respective metrics of the video quality measurement items are equalized to a 10 point maximum as shown, for example, in FIG. 9A, the relationship between the physical metrics and the video quality perception is a non-linear relationship as shown, for example, in FIG. 9B.

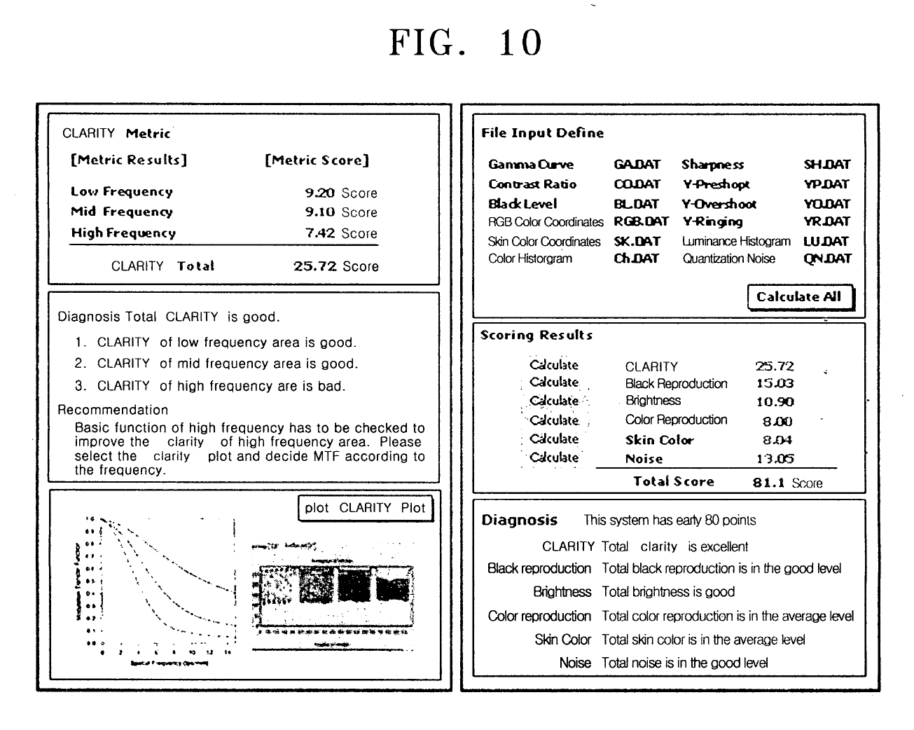

The video quality measuring system 100 outputs the result of video quality measurement on a screen, for example, as shown in FIG. 10. The result of video quality measurement displayed on the screen includes result values of clarity metrics, diagnosis of the results of the clarity metrics, a graph of the clarity metrics, file input definition, score results of measurement items, and diagnosis of each measurement item.

According to the present invention as described above, since the video quality of the image displayed is measured by a measurer in a darkroom where no affecting environment factor exists, the subjective video quality measurement is performed on the spot and is expressed by scores.

A process of arranging a new video quality measuring group and receiving scores from them every time when a new display system is developed is not required. Accordingly, time and cost required to develop a display system can be reduced. Also, variation in the video quality measurement, which is subsequent to various tastes of the video quality measurers and various viewing environments, can be excluded. Accordingly, reliability of the video quality measurement can be increased.

What is claimed is:

1. A method for measuring video quality, comprising:
receiving subjective video quality measuring data from a plurality of video quality measurers;
photographing or capturing a test-target video image and receiving image data;
calculating video quality measurement factor values with respect to the received image data, item by item;
reflecting the video quality measurement factor values to the subjective video quality measuring data through video quality modeling;
mapping results of the reflecting into scores;
weighting the video quality measurement factor values according to their correlations with the subjective video quality measuring data; and
outputting objective video quality measuring data on a screen.

2. The method as claimed in claim 1, wherein the subjective video quality measuring data includes metrics regarding clarity, contrast ratio of lightness to darkness, brightness, color reproduction, and noise.

3. The method as claimed in claim 1, wherein the objective video quality measuring data includes metrics regarding clarity, contrast ratio of lightness to darkness, brightness, color reproduction, noise, and distortion characteristic.

4. The method as claimed in claim 2, wherein each of the metrics includes its own single measurement value,
wherein each of the results of reflecting the video quality measurement factor values to the subjective video quality measuring data includes a single weight factor for each measurement value, and
wherein the objective video quality measuring data is obtained by multiplying the metric measurement values by respective weight factors of the metric measurement values and summing up the multiplied values.

5. The method as claimed in claim 3, wherein each of the metrics includes its own single measurement value,
wherein each of the results of reflecting the video quality measurement factor values to the subjective video quality measuring data includes a single weight factor for each measurement value, and
wherein the objective video quality measuring data is obtained by multiplying the metric measurement values by respective weight factors of the metric measurement values and summing up the multiplied values.

6. The method as claimed in claim 1, wherein the objective video quality measuring data is output as numerical data with respect to each measurement item, and
wherein the objective video quality measuring data also is output as measurement contents for each measurement item.

7. A video quality measuring system comprising:
a subjective video quality measurement input unit that receives subjective video quality measuring data from a plurality of video quality measurers;
an objective video quality measuring unit that receives image data which is obtained by photographing or capturing a test-target video image and calculates video quality measurement factor values with respect to the received image data, video quality measurement item by video quality measurement item;
a video quality modeling unit that reflects the video quality measurement factor values to the subjective video quality measuring data through video quality modeling and maps results of the reflecting into scores; and
a video quality measuring algorithm unit that weights the video quality measurement factor values according to their correlations with the subjective video quality measuring data and outputs objective video quality measuring data on a first screen.

8. The video quality measuring system as claimed in claim 7, wherein the objective video quality measuring unit comprises:
a video displayer that outputs test-target video data on a second screen;
a photographing device that photographs or captures a video image from the video displayer and outputs it as image data; and
a measurement data calculator that calculates numerical data with respect to the photographed or captured image data, video quality measurement item by video quality measurement item.

9. The video quality measuring system as claimed in claim 7, wherein the subjective video quality measuring data includes metrics regarding clarity, contrast ratio of lightness to darkness, brightness, color reproduction, and noise.

10. The video quality measuring system as claimed in claim 7, wherein the objective video quality measurement data includes metrics regarding clarity, contrast ratio of lightness to darkness, brightness, color reproduction, noise, and distortion characteristic.

11. The video quality measuring system as claimed in claim 10, wherein the clarity has metrics including Y-Preshoot, Y-Overshoot, Y-Ringing, and modulation transfer function (MTF);
wherein the contrast ratio of lightness to darkness has metrics including black and white saturation, gamma curve, contrast ratio, and black level;
wherein the brightness has metrics including luminance histogram and luminance;
wherein the color reproduction has metrics including color histogram, RGB color coordinates, skin color coordinates, white balance, and color saturation;
wherein the noise has metrics including quantization noise and C/Y-SN; and
wherein the distortion characteristic has metrics including H/V linearity and circle-distortion.

12. The video quality measuring system as claimed in claim 7, wherein the video quality modeling unit has video quality measurement correlations with respect to metrics of the video quality measurement items.

13. The video quality measuring system as claimed in claim 12, wherein each of the metrics includes its own single measurement value,
wherein each of the results of reflecting the video quality measurement factor values to the subjective video quality measuring data includes a single weight factor for each measurement value, and
wherein the objective video quality measuring data is obtained by multiplying the metric measurement values by respective weight factors of the metric measurement values and summing up the multiplied values.
